(19) United States
(12) Patent Application Publication
(10) Pub. No.: US 2012/0190762 A1
(43) Pub. Date: Jul. 26, 2012

(54) USE OF SILICONE-POLYETHER BLOCK COPOLYMERS WITH HIGH MOLECULAR WEIGHT NON-ENDCAPPED POLYETHER MOIETIES AS STABILIZERS FOR PRODUCTION OF LOW-DENSITY POLYURETHANE FOAMS

(75) Inventors: Roland Hubel, Essen (DE); Annegret Terheiden, Alpen (DE); Carsten Schiller, Muelheim an der Ruhr (DE); Frauke Henning, Essen (DE); Sarah Schmitz, Essen (DE)

(73) Assignee: EVONIK GOLDSCHMIDT GMBH, Essen (DE)

(21) Appl. No.: 13/358,128

(22) Filed: Jan. 25, 2012

(30) Foreign Application Priority Data
Jan. 26, 2011 (DE) DE102011003148.0

(51) Int. Cl. C08L 75/04; C08J 9/00

(52) U.S. Cl. 521/112

(57) ABSTRACT

A process for production of polyurethane foams having a density of below 24.0 kg/m³ is provided. The process includes utilizing a silicone-polyether block copolymer comprising a polyorganosiloxane which includes at least one polyether moiety. The polyorganosiloxane has attached to it at least one non-endcapped polyether moiety having a molecular weight of not less than 4500 g/mol. Polyurethane foams and articles which are obtainable by the process of the present invention are also disclosed.

### FIELD OF THE INVENTION

The present invention relates to a process for production of polyurethane foams having a density of below 24 kg/m³, which comprises utilizing a silicone-polyether block copolymer comprising a polyorganosiloxane which includes at least one polyether moiety. The polyorganosiloxane that is employed has at least one non-endcapped polyether moiety having a weight average molecular weight of not less than 4500, and preferably not less than 5000 g/mol, attached to it. The present invention also relates to polyurethane foams obtainable by the process of the present application as well as articles containing these foams.

### BACKGROUND OF THE INVENTION

Polyurethanes of various kinds are obtained by the polymerization of diisocyanates such as 4,4′-methylenebis(phenyl isocyanate), MDI for short, or 2,4-tolylene diisocyanate, TDI for short, with polyether polyols or polyester polyols. The polyether polyols are obtained by the alkoxylation of polyhydroxy-functional precursors such as, for example, glycols, glycerol, trimethylolpropane, pentaerythritol, sorbitol or sucrose. Polyurethane foams are produced using additional blowing agents, for example, pentane, acetone, methylene chloride or carbon dioxide. An indispensable corequisite for reproducible industrial manufacture of foam parts includes using a surfactant to stabilize the polyurethane foam. Apart from the few purely organic surfactants, silicone surfactants are mostly used because of their higher interface stabilization potential.

A multiplicity of different polyurethane foams, for example, hot-cure flexible foam, cold-cure foam, ester foam, rigid PUR foam and rigid PIR foam, are known. Stabilizers have been specifically developed to match the particular end use, and typically give a distinctly altered performance if used in the production of other types of foam.

A multiplicity of documents, such as, for example, EP 0 493 836 A1, U.S. Pat. No. 5,565,194 or EP 1 350 804, disclose specifically assembled polysiloxane-polyoxyalkylene block copolymers to achieve specific profiles of requirements for foam stabilizers in diverse polyurethane foam formulations. To obtain the respective stabilizers involved, the hydrosilylation utilizes mixtures of two or three preferably endcapped allyl polyethers having molecular weights of less than 6000 g/mol and preferably less than 5500 g/mol. Polyethers with molecular weights above 4500 g/mol are not readily obtainable via alkaline alkoxylation, since secondary reactions that promote chain termination dominate with increasing chain length.

U.S. Pat. Nos. 5,856,369 and 5,877,268 describe polyether polysiloxanes which include two different kinds of polyether moieties: the first kind of polyether moiety has an average molar mass of more than 3000 g/mol. The second kind of polyether moiety has an average molar mass of 300 to 3000 g/mol. The average molar mass of all polyether moieties is in the range from 1100 to 3000 g/mol. The polyether moieties may be capped or uncapped. In some embodiments, the polyether moieties are preferably endcapped. Particular preference is given to the polyether moieties of the first kind where the average molar mass is above 6000 g/mol and there is t-butyl, methyl or acetyl endcapping.

As explained in U.S. Pat. Nos. 5,856,369 and 5,877,268, it is the high chemical purity and the high molar mass combined with low polydispersity which causes the unsaturated polyetherols obtained via DMC catalysts to give polyurethane foam stabilizers of high activity. However, the usefulness of the polyetherols described, which are usually started on allyl alcohol, in the field of PU foam stabilizers is limited to a relatively small group of polyetherols that consist of ethylene oxide and propylene oxide monomer units in partly randomly mixed sequence and, in which the ethylene oxide fraction does not exceed 60 mol % in order that the formation of polyethylene glycol blocks in the polymer chain may be avoided. The solubility and hence also the efficaciousness of the stabilizers described therein are substantially limited in formulations with comparatively hydrophilic polyols. In addition to universal utility in various formulations, processing latitude is also an important factor governing the usefulness of a stabilizer. A wide processing latitude means that foam properties remain constant in the event of dosage fluctuations for the starting materials. Processing latitude can be determined by varying the use levels of stabilizer and catalyst. As a person skilled in the art knows, high-activity stabilizers, for example the silicone-polyether copolymers described in U.S. Pat. Nos. 5,856,369 and 5,877,268, usually have too little processing latitude. U.S. Pat. No. 5,856,369, U.S. Pat. No. 5,877,268 and EP 0 712 884 show that the use of particularly long-chain polyethers in the polyoxyalkylene moiety of the silicone-polyether copolymer leads to more viscous products which first have to be thinned with solvents in order that normal handling may be ensured. The aforementioned publications further mention the parameter of the blend average molecular weight of the polyether mixture, which is less than 3000 g/mol and preferably even below 2000 g/mol in order that excessively high viscosities may be avoided and open-cell polyurethane foams may be ensured. The low blend average molecular weights mentioned are attributable to the comparatively low fractions in the blend of allyl polyethers having molecular weights above 5500 g/mol.

Especially polyurethane foam formulations having low densities have high requirements in respect of the activity of the stabilizer and also in respect of its cell-refining and cell-opening properties. As a person skilled in the art knows, these two contrary properties are usually only combinable with each other to a certain extent. U.S. Patent Application Publication No. 2009/0253817 A1 describes the use of silicone-polyether copolymers whose polyether mixture consists of three individual polyethers, namely two endcapped allyl polyethers with average to low molecular weights in the range from 800 g/mol to not more than 5500 g/mol and a hydroxy-functional allyl polyether having a molecular weight of 1400 g/mol to 2300 g/mol. As reference examples 2.1 and 2.2 in the '817 publication show, the high activity of these stabilizers is associated with reductions in open-cell content.

Patent Application CN 101099926 A describes endcapped nonionic surfactants and their use in an undisclosed polyurethane foam formulation used to produce foams of medium or low density. Although the use of endcapped polyethers having molecular weights up to 9500 g/mol is mentioned as an in-principle possibility in the description, the disclosed examples merely describe the use of methylated allyl polyethers having molecular weights of 1000 to 4500 g/mol. As reference examples 2.3 and 2.4 in CN '926, the stabilizers disclosed therein have disadvantages which, in low-density foams, either lead to coarse cell structure or, because of the absence of sufficiently stabilizing properties, directly to foam collapse.

### SUMMARY OF THE INVENTION

In one embodiment, the present invention provides simple-to-obtain silicone-polyether block copolymers having a balanced profile of properties with regard to stabilizing polyurethane foams of medium to low density (below 24 kg/m³).

The present invention thus provides a process for production of polyurethane foams having a density of below 24 kg/m³, which comprises utilizing a silicone-polyether block copolymer comprising a polyorganosiloxane which includes at least one polyether moiety. The polyorganosiloxane employed in the present invention has at least one non-endcapped polyether moiety having a molecular weight of not less than 4500 g/mol attached to it.

The present invention also provides polyurethane foams obtainable by the process of the present invention and also articles containing or consisting of this polyurethane foam of the present invention.

The silicone-polyether block copolymers employed in the present invention have the advantage that the polyethers used for their production are simple to obtain from allyl polyethers obtained via DMC catalysis. As such, only a small proportion of propenyl polyether is obtained.

The silicone-polyether block copolymers employed in the present invention also have the advantage that they are obtainable without an additional, costly, inconvenient step of endcapping.

The silicone-polyether block copolymers employed in the present invention also have the advantage that they are obtainable without an additional, costly, inconvenient step of neutralization and/or filtration.

There is a further advantage to silicone-polyether block copolymers in the use according to the present invention in that low use levels of the copolymers are sufficient for production of fine- and open-cell hot-cure flexible and rigid polyurethane foams having low densities.

Compared with equal use levels to the prior art, there is a further advantage to silicone-polyether block copolymers in the use according to the present invention in that a distinctly finer cellular structure coupled with unchanged open-cell content is obtained particularly in the case of foams having a density of below 12 kg/m³ and preferably below 10 kg/m³.

For the same degree of mixing of the concentrate with a solvent (dipropylene glycol for example) compared with the prior art, the percentage fraction of silicone in the silicone-polyether block copolymer of the present invention can be reduced, which reduces costs.

A further advantage with silicone-polyether block copolymers employed in the present invention is that, particularly in the case of rigid foam applications such as sprayable foam and packaging foam, the use of polyether siloxanes containing non-endcapped high molecular weight polyethers provides enhanced phase compatibility in the polyol component of the polyurethane system and hence in comparison with the polyethersiloxanes containing endcapped polyethers, which are used in the prior art.

A further advantage with silicone-polyether block copolymers used according to the present invention is that, in the case of rigid foam applications described above, the use of polyether siloxanes containing non-endcapped high molecular weight polyethers provides an improved cell structure, lower void rate and reduced thermal conductivity compared with the polyethersiloxanes containing non-endcapped polyethers, which are also used in the prior art.

### DETAILED DESCRIPTION OF THE INVENTION

The silicone-polyether block copolymers used according to the present invention and their production will now be described by way of example without any intention to restrict the invention to these exemplary embodiments. Where ranges, general formulae or classes of compounds are indicated in what follows, they shall encompass not just the corresponding ranges or groups of compounds that are explicitly mentioned, but also all sub-ranges and sub-groups of compounds which are obtainable by extraction of individual values (ranges) or compounds. Where documents are cited in the context of the present description, their content shall fully belong to the disclosure content of the present invention. Percentages are by weight, unless otherwise stated. Averages reported hereinbelow are by weight, unless otherwise stated.

In the context of the present invention, polyurethane foams are said to be of medium density when their density is below 24 kg/m³ and of low density when their density is below 15.8 kg/m³. Density is determined as described under Test A in ASTM D 3574-08.

The hereinbelow indicated weight average molecular weight of all polyether moieties attached to the polyorganosiloxane by chemical bonding—MW_{blend}—is defined as the sum total of the products formed from the percentage molar fractions of the respective polyether moiety in the blend, fₘₒₗₐᵣ, and its individual molecular weight, MW_{polyether}. (formula X)

MW_{blend}=Σ[fₘₒₗₐᵣ×MW_{polyether]} Formula X

The process of the present invention for production of polyurethane foams having a density of below 24 kg/m³, preferably below 20 kg/m³, more preferably below 15.8 kg/m³, even more preferably below 13 kg/m³ and yet even more preferably in the range from 3.5 to 12 kg/m³, comprises utilizing a silicone-polyether block copolymer comprising a polyorganosiloxane which includes at least one polyether moiety and is distinguished in that the polyorganosiloxane has attached to it at least one non-endcapped polyether moiety (polyether moiety with a free OH group) having a molecular weight of not less than 4500 g/mol, preferably not less than 5000 g/mol and more preferably in the range from 6000 to 8000 g/mol.

The weight average molecular weight of all polyether moieties attached to the polyorganosiloxane by chemical bonding is preferably above 1500 g/mol, more preferably above 2000 g/mol and even more preferably in the range from above 3000 to below 5000 g/mol.

The polyorganosiloxane in the silicone-polyether block copolymers used according to the present invention preferably has attached to it by chemical bonding at least one polyether moiety having a molecular weight of below 4500 g/mol and preferably below 4000 g/mol as well as the polyether moiety having a molecular weight of not less than 4500 g/mol.

The silicone-polyether block copolymers used according to the present invention preferably satisfy formula (I):

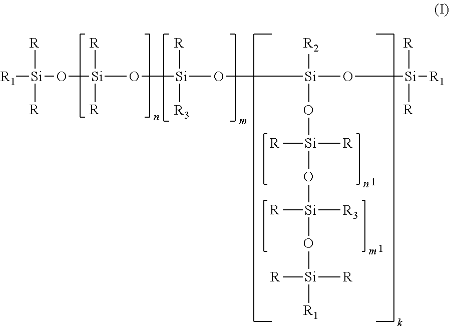

wherein

n and n¹ are each independently from 0 to 500, preferably 10 to 200 and more particularly 15 to 100 and (n+n¹) is <500, preferably <200 and more particularly <100,

m and m¹ are each independently from 0 to 60, preferably 0 to 30 and more particularly 0.1 to 25 and (m+m¹) is <60, preferably <30 and more particularly <25,

k is from 0 to 50, preferably from 0 to 10 and more particularly 0 or from 1 to 5,

R represents alike or unalike moieties from the group of linear, cyclic or branched, aliphatic or aromatic, saturated or unsaturated hydrocarbon moieties having from 1 up to 20 carbon atoms,

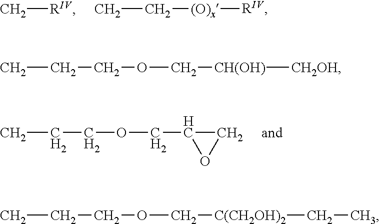

where

x′ is 0 or 1 and

R^{IV} is an optionally substituted, optionally halogen-substituted hydrocarbon moiety having 1 to 50 carbon atoms,

wherein R is preferably a methyl moiety, wherein all R moieties are more preferably methyl moieties,

R₁ is R or R₃ or R₇,

R₂ is R or R₃ or R₇ or a heteroatom-substituted, functional, organic, saturated or unsaturated moiety, preferably selected from the group of alkyl, chloroalkyl, chloroaryl, fluoroalkyl, cyanoalkyl, acryloyloxyaryl, acryloyloxyalkyl, methacryloyloxyalkyl, methacryloyloxypropyl or vinyl moieties, more preferably a methyl, chloropropyl, vinyl or methacryloyloxypropyl moiety,

R₃ is -Q-O—(CH₂—CH₂O—)ₓ—(CH₂—CH(R′)O—)_{z}—(80),-R″

or

-Q-O—(CH₂—CH_{2l O—)}ₓ—(CH₂—CH(R′)O—)_{y}—R″,

where

Q=divalent hydrocarbon moiety having 2 to 4 carbon atoms, preferably Q=—CH₂—CH₂—CH₂— or —CH₂—CH₂—

SO=styrene oxide unit,

x=0 to 200, preferably from 5 to 140 and more preferably from 10 to 100,

y=0 to 200, preferably from 5 to 140 and more preferably from 10 to 100,

z=0 to 100, preferably from 0 to 10,

R′ is an identical or different alkyl or aryl group which has a total of 1 to 12 carbon atoms and is unsubstituted or optionally substituted, for example with alkyl moieties, aryl moieties or haloalkyl or haloaryl moieties, preferably a methyl or ethyl group, more preferably a methyl group, and

R″ is a hydrogen moiety or an alkyl group having 1 to 4 carbon atoms, a —C(O)—R′″ group where R′″ is an alkyl moiety, a —CH₂—O—R′ group, an alkylaryl group, e.g. benzyl, a —C(O)—O—R″″ group where R″″ is an alkyl moiety or alkylaryl, the —C(O)—OR′ group or the —C(O)NH—R′ group, preferably a hydrogen moiety or a methyl, butyl or acetyl moiety,

SO is a styrene oxide moiety —CH(C₆H₅)—CH₂—O—,

R₇=branched polyether moiety or crosslinker moiety as derives for example from diallyl compounds or converted diallyl compounds,

with the proviso that at least one R₃ moiety is present where the R₃ moiety is a polyether moiety having a molecular weight of not less than 4500 g/mol, and where R″ is an H and n+n¹+m+m¹ is not less than 10, preferably 30 and more, preferably not less than 50.

The various monomer units of the polyorganosiloxane chain and also of the polyoxyalkylene chain can each have a blockwise construction or form a random distribution. The index numbers shown in the formulae of the present application and the value ranges for the indicated indices are therefore understood as the average values of the possible statistical distribution of the actually isolated structures and/or mixtures thereof.

In some embodiments, it may be advantageous when R″ is hydrogen for all polyether moieties R₃ having a molecular weight not less than 4500 g/mol. In other embodiments, it may also be advantageous when R″ is other than hydrogen for all polyether moieties R₃ having a molecular weight below 4500 g/mol. Preferably R″ is hydrogen for all polyether moieties R₃ having a molecular weight not less than 4500 g/mol and is other than hydrogen for all polyether moieties R₃ having a molecular weight below 4500 g/mol.

The silicone-polyether block copolymers of the present invention are obtainable by organomodification of branched or linear polyorganosiloxanes having end-disposed and/or side-disposed SiH functions, with a polyether or polyether mixture of two or more polyethers distinguished in that the polyether or polyether mixture used is, or contains, at least one non-endcapped polyether having a molecular weight not less than 4500 g/mol. The average molecular weight of all polyethers used is preferably above 1500 g/mol, more preferably above 2000 and even more preferably in the range from above 3000 to below 5000. In some embodiments, preference is given to using polyethers having an end group which contains a vinyl end group and which is more particularly an allyl group.

The silicone-polyether block copolymers of the present invention are obtainable in various ways using process steps known in the art.

The silicone-polyether block copolymers used are obtainable by a process which comprises branched or linear polyorganosiloxanes having end-disposed and/or side-disposed SiH functions being reacted with a polyether or polyether mixture of two or more polyethers, wherein the polyether or polyether mixture used is or contains at least one polyether having a molecular weight not less than 4599 g/mol, preferably 4999 g/mol and more preferably 5999 g/mol and the average molecular weight of all polyethers used is above 1499 g/mol, preferably above 1999 g/mol and more preferably in the range above 2999 to 4999 g/mol. The polyethers used are preferably polyethers containing an end group which contains a vinyl end group and is more particularly an allyl group.

The reaction is preferably carried out as noble metal-catalyzed hydrosilylation, preferably as described in EP 1 520 870.

The process for producing the silicone-polyether block copolymers preferably utilizes polyorganosiloxanes having end-disposed and/or side-disposed SiH functions, of formula (II)

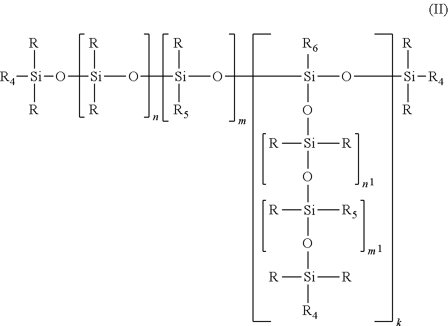

wherein

n and n¹ are each independently from 0 to 500, preferably from 10 to 200 and more particularly from 15 to 100 and (n+n¹) is <500, preferably <200 and more particularly <100,

m and m¹ are each independently from 0 to 60, preferably from 0 to 30 and more particularly from 0.1 to 25 and (m+m¹) is <60, preferably <30 and more particularly <25,

k=0 to 50, preferably from 0 to 10 and more particularly 0 or from 1 to 5,

R is as defined above,
R₄ in each occurrence independently is hydrogen or R,
R₅ in each occurrence independently is hydrogen or R,
   R₆ in each occurrence independently is hydrogen, R or a heteroatom-substituted, functional, organic, saturated or unsaturated moiety, preferably selected from the group of alkyl, chloroalkyl, chloroaryl, fluoroalkyl, cyanoalkyl, acryloyloxyaryl, acryloyloxyalkyl, methacryloyloxyalkyl, methacryloyloxypropyl or vinyl moieties and more preferably is a methyl, chloropropyl, vinyl or methacryloyloxypropyl moiety,
      with the proviso that at least one of R₄, R₅ and R₆ is hydrogen.

The polyorganosiloxanes having end-disposed and/or side-disposed SiH functions of formula (II), which are used to form the polysiloxane-polyoxyalkylene block copolymers, are obtainable as described in the prior art, for example in EP 1439200 B1 and DE 10 2007 055485 A1.

The unsaturated polyoxyalkylenes used (polyethers having a vinyl end group and more particularly an allyl end group) are obtainable by the literature method of alkaline alkoxylation of a vinyl-containing alcohol, especially allyl alcohol, or by using DMC catalysts as described in the prior art, for example in DE 10 2007 057145 A1.

Preferably employed unsaturated polyoxyalkylenes are of formula (III)

Q′-O—(CH₂—CH₂O—)ₓ—(CH₂—CH(R′)O—)_{y}—(SO)_{z}—R″ (III)

Q′=CH₂═CH—CH₂— or CH₂═CH— and SO, R′, R″, x, y and z are each as defined above, with the proviso that the sum total of x+y+z is other than 0 and preferably is chosen such that the abovementioned weight average molecular weights are obtained.

The silicone-polyether copolymers may be used in the process of the present invention alone or in the form of a composition. Preferred compositions contain one or more silicone-polyether copolymers and are characterized in that the compositions furthermore contain one or more substances useful in the production of polyurethane foams and selected from polyol, nucleating agents, cell-refining additives, cell openers, crosslinkers, emulsifiers, flame retardants, antioxidants, antistats, biocides, colour pastes, solid fillers, catalysts, in particular amine catalysts and/or metal catalysts and buffer substances. In one embodiment, it is advantageous when the composition of the present invention contains one or more solvents, preferably selected from glycols, alkoxylates or oils of synthetic and/or natural origin.

The process of the present invention for producing the polyurethane foam is well known, apart from the use of the specific silicone-polyether copolymers, and therefore can be carried out as described in the prior art.

Following is a list of property rights which describe suitable components and processes for producing the different flexible polyurethane foam types, i.e. hot-cure, cold-cure and also ester type flexible polyurethane foams, and which are fully incorporated herein by reference: EP 0152878 A1; EP 0409035 A2; DE 102005050473 A1; DE 19629161 A1; DE 3508292 A1; DE 4444898 A1; EP 1061095 A1; EP 0532939 B1; EP 0867464 B1; EP 1683831 A1; and DE 102007046860 A1.

Further particulars concerning usable starting materials, catalysts and also auxiliary and addition agents are found for example in Kunststoff-Handbuch, volume 7, Polyurethanes, Carl-Hanser-Verlag Munich, 1^{st} edition, 1966, 2^{nd} edition, 1983 and 3^{rd} edition, 1993.

In one embodiment, the polyurethane foams are prepared by reacting at least one polyol compound and at least one isocyanate compound in the presence of the silicone-polyether block copolymer of the present invention.

PU foams and PU foam production are described in general terms, for example, in Ullmann's Encyclopedia of Industrial Chemistry, headword: Polyurethanes, Published Online: 15 Jan. 2005, DOI: 10.1002/14356007.a21_{—}665.pub2, Wiley-VCH Verlag GmbH & Co. KGaA, Weinheim and in the literature cited therein.

The silicone-polyether block copolymers of the present invention are preferably used as foam stabilizer in the process of the present invention. The silicone-polyether block copolymers, especially those of formula (I), are suitable with particular preference as polyurethane foam stabilizers in the production of, for example, polyurethane flexible foam, hot-cure flexible foam, rigid foam, cold-cure foam, ester foam, viscoelastic flexible foam or else high resilience foam (HR foam), and with very particular preference as polyurethane flexible hot-cure foam stabilizers and polyurethane rigid foam stabilizers.

Polyurethane foam is preferably produced in the process of the present invention utilizing water, methylene chloride, pentane, alkanes, halogenated alkanes, acetone and/or carbon dioxide and preferably water, pentane, cyclopentane or carbon dioxide as a blowing agent.

The process of the present invention provides polyurethane foams which are in accordance with the present invention. The polyurethane foams in accordance with the present invention include the specific silicone-polyether copolymers.

The polyurethane foam of the present invention is obtained using a silicone-polyether block copolymer of the present invention. The polyurethane foam of the present invention provides articles which contain or consist of this polyurethane foam. Such articles can be, for example, furniture cushioning, refrigerator insulation, sprayable foams, metal composite elements for (building) insulation, mattresses or auto seats. The lists are to be understood as overlapping and as not-conclusive.

The subject matter of the present invention is further described using examples without any intention to restrict the subject matter of the invention to these exemplary embodiments.

### EXAMPLES

### Example 0

### Production of Silicone-Polyether Block Copolymers

The polyethers were obtained using familiar prior art methods. The molecular weights Mₙ and M_{w} were determined by gel permeation chromatography under the following conditions of measurement: column combination SDV 1000/10 000 Å (length 65 cm), temperature 30° C., THF as mobile phase, flow rate 1 ml/min, sample concentration 10 g/l, RI detector, evaluation against polypropylene glycol standard.

Polyethers of formula (III) each with Q=CH₂═CH—CH₂— and R′═—CH₃ are used:

PE1: R″═H, z=0, x=16, y=12, M_{w}=1459 g/mol

PE2: R″═C(O)—CH₃, z=0, x=16, y=12, M_{w}=1484 g/mol

PE3: R″═C(O)—CH₃, z=0, x=40, y=30, M_{w}=3832 g/mol

PE4: R″═H, z=0, x=57, y=60, Mₙ=5226 g/mol, M_{w}=6872 g/mol

PE5: R″═CH₃, z=0, x=17.7, y=23.6, M_{w}=2206 g/mol

PE6: R″═CH₃, z=0, x=47, y=49, M_{w}=4983 g/mol

PE7: R″═H, z=0, x=78, y=81, Mₙ=7032 g/mol, M_{w}=9871 g/mol

PE8: R″═H, z=0, x=10, y=16, M_{w}=1373 g/mol

The hydrosiloxanes were obtained as described in Inventive Example 1 of EP 1439200 B1. The hydrosiloxanes used are defined as follows in accordance with formula (II):

SIL1: R₄═R═CH₃, R₅═H, k=0, n=70, m=5

SIL2: R₄═R═CH₃, R₅═H, k=0, n=69, m=8

SIL3: R₄═R═CH₃, R₅═H, k=0, n=89, m=6.5

SIL4: R₄═R═CH₃, R₅═H, k=0, n=74, m=4.0

The polyethersiloxanes listed in Table 1 and Table 2 were obtained as described in Example 7 of WO 2009/065644.

TABLE 1
Inventive silicone-polyether block copolymers

| | | | | | | | Appearance |
|---|---|---|---|---|---|---|---|
| Example | | | Weights of individual | | | | of polyether |
| No. | Siloxane | Amount | polyethers used | | | MW_{blend} | siloxane |
| 0.1 | SIL3 | 41.0 g | 11.7 g | 33.4 g | 146.1 g | 3898 g/mol | slightly |
| | | | PE2 | PE8 | PE4 | | cloudy |
| 0.2 | SIL3 | 39.0 g | 11.0 g | 31.4 g | 155.2 g | 4295 g/mol | slightly |
| | | | PE2 | PE8 | PE7 | | cloudy |
| 0.3 | SIL4 | 41.0 g | 127.6 g | 35.6 g | — | 4372 g/mol | slightly |
| | | | PE7 | PE1 | | | cloudy |

TABLE 2
Noninventive silicone-polyether block copolymers

| | | | | | | | Appearance |
|---|---|---|---|---|---|---|---|
| Example | | | Weights of individual | | | | of polyether |
| No. | Siloxane | Amount | polyethers used | | | MW_{blend} | siloxane |
| V.1 | SIL1 | 63.2 g | 19.2 g | 62.0 g | 105.6 g | 2264 g/mol | clear |
| | | | PE1 | PE2 | PE3 | | |
| V.2 | SIL1 | 63.2 g | 38.3 g | 42.9 g | 105.6 g | 2258 g/mol | clear |
| | | | PE1 | PE2 | PE3 | | |
| V.3 | SIL2 | 40.0 g | 104.3 g | 138.4 g | — | 3227 g/mol | clear |
| | | | PE5 | PE6 | | | |
| V.4 | SIL2 | 40.0 g | 132.5 g | 74.8 g | — | 2761 g/mol | clear |
| | | | PE5 | PE6 | | | |

### Examples 1 to 6

### Production of Polyurethane Foams Using Stabilizers Containing High Molecular Weight Polyethers

Low-density polyurethane foams were obtained using the following recipe: 100 parts by weight of polyetherol (hydroxyl number=56 mg KOH/g), 11 parts by weight of water, 10 parts by weight of silicone stabilizer, 0.9 part by weight of a tertiary amine (TEGOAMIN® SMP from Evonik Goldschmidt GmbH), 140 parts by weight of a tolylene diisocyanate T 80 (Index 122), 90 parts by weight of methylene chloride, and also 1 part by weight of KOSMOS® 29 (Evonik Goldschmidt GmbH).

The amount of polyol used in foaming was 80 g, the other constituents of the formulation were recalculated accordingly.

For foaming, the polyol, water, amine, tin catalyst and silicone stabilizer were thoroughly mixed under agitation. Following simultaneous addition of methylene chloride and isocyanate the mixture was stirred at 2500 rpm with a stirrer for 7 seconds. The mixture obtained was poured into a paper-lined wooden box (base area 27 cm×27 cm). A foamed material was formed and subjected to the performance tests described hereinbelow.

For comparison, low-density foams were produced using a conventional stabilizer which is entirely suitable for foaming in low densities, but merely includes polyethers with molecular weight <4000 g/mol.

Physical properties of foams

The foams obtained were evaluated by the following physical properties:

a) Rise time:
Time difference between pouring in the starting mixture and blow-off of the polyurethane foam.

b) Settling of foam at end of rise period:
Settling or conversely post-rise was obtained from the difference in foam height after direct blow-off and after 3 min after blow-off of the foam. Foam height was measured using a needle secured to a centimetre scale, on the peak in the middle of the foam top surface.

c) Foam height:
The final height of the foam was determined by subtracting the settling from or adding the post-rise to the foam height after blow-off.

d) Cell structure:
A horizontal foam disc 0.8 cm in thickness was cut out at a point 10 cm from the base of the foam body and visually compared with five standard foam discs having various cell structure qualities. A characterization of 1 describes substantial coarsening particularly in the edge region, while a characterization of 5 represents a uniform, fine cell.

The results are summarized in Table 3.

TABLE 3
Foaming results of example foams 1-6

| Ex. | Silicone- | Rise time | Settling | Foam height | Cell structure |
|---|---|---|---|---|---|
| No. | polyether | [s] | [cm] | [cm] | assessment |
| 1 | 0.1 | 92 | 1.0 | 37.1 | 3-4 |
| 2 | 0.2 | 95 | 1.2 | 36.7 | 4-5 |
| 3 | V.1 | 101 | 1.6 | 35.9 | 3 |
| 4 | V.2 | 94 | 1.4 | 37.5 | 3-4 |
| 5 | V.3 | 110 | 1.9 | 33.4 | 2-3 |
| 6 | V.4 | 117 | — | — | collapse |

As is evident from Table 3, cell structure improved dramatically on using foam stabilizers containing high molecular weight, non-endcapped polyethers (silicone-polyether nos. 0.1 and 0.2). The use of polyethers having a molecular weight around 8000 g/mol made it possible to prepare stabilizers which appreciably improved foam quality and obtained a rating of 4 to 5. In addition, the settling of the foam was dramatically reduced when using long-chain polyethers, which gave improved foam yield. This pointed to an improved stabilization property of the novel structures particularly for foaming in low density.

### Examples 7 to 14

### Production of Flame-Retardant Polyurethane Foams Using Stabilizers Containing High Molecular Weight Polyethers

Flame-retardant polyurethane foams were obtained using the following recipe: 100 parts by weight of polyetherol (hydroxyl number=48 mg KOH/g), 4.4 parts by weight of water, 1.5 parts by weight of silicone stabilizer, 0.15 part by weight of a tertiary amine (TEGOAMIN B75 from Evonik Goldschmidt GmbH), 55 parts by weight of tolylene diisocyanate T 80 (Index 110), a variable amount of FR additive, and also 0.2 part by weight of KOSMOS® 29 (Evonik Goldschmidt GmbH).

The amount of polyol used in foaming was 300 g, the other constituents of the formulation were recalculated accordingly.

For foaming, the polyol, water, amine, tin catalyst, flame-retardant additive and silicone stabilizer were thoroughly mixed under agitation. Following addition of isocyanate the mixture was stirred at 2500 rpm with a stirrer for 7 seconds. The mixture obtained was poured into a paper-lined perforated metal box (base area 40 cm×16 cm). A foamed material was formed and subjected to flame tests according to CALIFORNIA-Test T.I.B 117 (CAL 117). Table 4 summarizes the flame test results of example foams 7 to 14 using halogenated and non-halogenated flame retardants.

TABLE 4
Results of CAL 117 flame test (to technical information
bulletin 177 section A part 1) using halogenated and
non-halogenated flame retardant additives.

| | | FR additive | | CAL 117 |
|---|---|---|---|---|
| Ex. | Silicone- | | Amount used | Burn length* |
| No. | polyether | Type | [pphp] | [in] |
| 7 | 0.1 | TCPP | 9 | 7.6 |
| 8 | 0.1 | not halogenated | 16 | 11.7 |
| 9 | 0.2 | TCPP | 9 | 7.1 |
| 10 | 0.2 | not halogenated | 16 | 8.9 |
| 11 | V.1 | TCPP | 9 | —** |
| 12 | V.1 | not halogenated | 16 | cracks |
| 13 | V.2 | TCPP | 9 | —** |
| 14 | V.2 | not halogenated | 16 | —** |

TCPP = tris(chloropropyl) phosphate
Not halogenated = halogen-free phosphoric ester with 8.1 wt % phosphorus fraction (Fyrol ® HF-4, from ICL Industrial Products)
*average values of five burn tests
**fully burned

From the flame test results it was evident that although example foams 7 to 10 do not pass the CAL 117 test, burn length was reduced compared with the noninventive foams 11 to 14.

### Example 15

### Production of Polyurethane Packaging Foam

The performance comparison of inventive and conventional foam stabilizers was carried out using the polyurethane packaging foam formulation indicated in Table 5.

TABLE 5
Formulations of packaging foam

| Component | Use level (parts by mass) | |
|---|---|---|
| Daltolac R 251* | 52 | parts |
| Voranol CP 3322** | 23 | parts |
| Desmophen PU 21IK01*** | 20 | parts |
| polyethylene glycol 600 | 5 | parts |
| N,N-dimethylaminoethoxyethanol | 2.5 | parts |
| Water | 35 | parts |
| Stabilizer | 1 | part |
| Desmodur 44V20L^{‡‡} | 226 | parts |

*polyether polyol from Huntsman
**polyether polyol from DOW
***polyether polyol from Bayer
^{‡‡}polymeric MDI from Bayer, 200 mPa*s, 31.5% NCO, functionality 2.7

The comparative foamings were carried out by hand mixing. Polyols, catalysts, water, cell opener and conventional or inventive foam stabilizer were weighed into a beaker and mixed together with a plate stirrer (6 cm diameter) at 1000 rpm for 30 s. MDI was then added, the reaction mixture was stirred at 2500 rpm with the described stirrer for 5 s and immediately transferred into an upwardly open wooden box having a base area of 27 cm×27 cm and a height of 27 cm and lined with paper.

After 10 min, the foams were demoulded and analyzed. Cell structure was evaluated subjectively against a scale from 1 to 10, where 10 represents a very fine-cell and undisrupted foam and 1 represents a coarse, extremely disrupted foam. The percentage volume content of open cells was determined using an AccuPyc 1330 instrument from Micromeritics. Density was determined by weighing a 10 cm×10 cm×10 cm cube of the foam.

The foam stabilizers used and the related foaming results are collated in Table 6.

TABLE 6
Packaging foam results

| Stabilizer | Cell structure | Density [kg/m³] |
|---|---|---|
| Ex. 1.3 | 5 | 6.8 |
| B 8863Z* | 4 | 7.1 |

*noninventive, comparative example; conventional foam stabilizer from Evonik Goldschmidt (TEGOSTAB ® 8863Z)

The results show that the foam stabilizers of the present invention can be used to obtain polyurethane packaging foam having a good cell structure and comparatively few foam defects.

### Example 16

### Production of Sprayable Polyurethane Foam of Low Density

The performance comparison of inventive and conventional foam stabilizers was carried out using the purely water-driven sprayable lightweight foam formulation indicated in Table 7.

TABLE 7
Formulation of sprayable foam

| | Use level | |
|---|---|---|
| Component | (parts by mass) | |
| castor oil | 25.0 | parts |
| Stepan PS 1922* | 7.5 | parts |
| Jeffol R-470 X** | 7.0 | parts |
| tris(1-chloro-2-propyl) phosphate | 20.0 | parts |
| PHT-4-Diol*** | 10.0 | parts |
| Tegoamine BDE^{‡} | 3.0 | parts |
| Tegoamine 33^{‡} | 2.5 | parts |
| Tegoamine DMEA^{‡} | 3.0 | parts |
| Water | 19.0 | parts |
| Stabilizer | 3.0 | parts |
| Rubinate M^{‡‡} | 100 | parts |

*polyester polyol from Stepan
**Mannich base-initiated polyether polyol from Huntsman
***flame retardant from Chemtura
^{‡}amine catalysts from Evonik Goldschmidt GmbH
^{‡‡}polymeric MDI from Huntsman, 190 mPa*s, 31.2% NCO, functionality 2.7

The comparative foamings were carried out by hand mixing. Polyols, catalysts, water, flame retardant and conventional or inventive foam stabilizers were weighed into a beaker and mixed together with a plate stirrer (6 cm diameter) at 1000 rpm for 30 s. MDI was then added, the reaction mixture was stirred at 3000 rpm with the stirrer described for 2 s and the foam was subsequently allowed to rise in the mixing beaker.

After a 10 min full-cure time, the foam was analyzed. Cell structure was rated subjectively on a scale from 1 to 10, where 10 represents a very fine-cell and undisrupted foam and 1 represents a coarse, extremely disrupted foam. The percentage volume content of open cells was determined using an AccuPyc 1330 instrument from Micromeritics. Density was determined by weighing a 10 cm×10 cm×10 cm cube of the foam.

All foam stabilizers used and the related foaming results are collated in Table 8.

TABLE 8
Results of sprayable foams

| | | Open cells | Density |
|---|---|---|---|
| Stabilizer | Cell structure | [%] | [kg/m³] |
| Ex. 0.3 | 8 | 84 | 9.3 |
| B 1048* | 7 | 88 | 11.1 |

*noninventive, comparative example; conventional foam stabilizer from Evonik Goldschmidt

The foam stabilizer of the present invention gave a lower foam density and an improved cell structure for the same open-cell content, manifesting the high activity of the foam stabilizers of the present invention.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A process for the production of polyurethane foams having a density of below 24 kg/m³, said process comprising reacting at least one polyol, at least one isocyanate and a silicone-polyether block copolymer, said silicone-polyether block copolymer comprising a polyorganosiloxane which includes at least one polyether moiety, wherein the polyorganosiloxane has attached to it at least one non-endcapped polyether moiety having a molecular weight of not less than 4500 g/mol.

2. The process according to claim 1, wherein the weight average molecular weight of all polyether moieties attached to the polyorganosiloxane by chemical bonding is above 1500 g/mol.

3. The process according to claim 1, wherein the silicone-polyether block copolymer comprises a silicone-polyether copolymer in which the polyorganosiloxane has attached to it by chemical bonding at least one polyether moiety having a molecular weight of not less than 4500 g/mol and at least one polyether moiety having a molecular weight of below 4500 g/mol.

4. The process according to claim 1, wherein the silicone-polyether block copolymer comprises a silicon-polyether block copolymer in which a weight average molecular weight of a sum total of all polyether moieties attached to the polyorganosiloxane by chemical bonding is in a range from above 3000 g/mol to below 5000 g/mol.

5. The process according to claim 1, wherein said silicone-polyether block copolymer is a copolymer of formula (I), 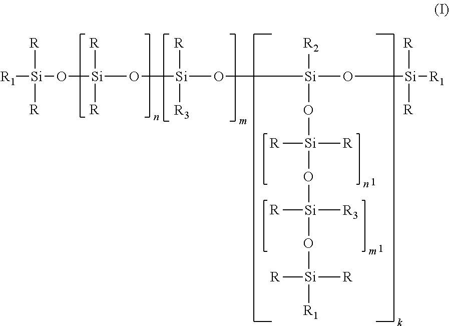
wherein
n and n¹ are each independently from 0 to 500 and (n+n¹) is <500,
m and m¹ are each independently from 0 to 60 and (m+m¹) is <60,
k is from 0 to 50,
R represents alike or unalike moieties selected from the group consisting of linear, cyclic or branched, aliphatic or aromatic, saturated or unsaturated hydrocarbon moieties having from 1 up to 20 carbon atoms, 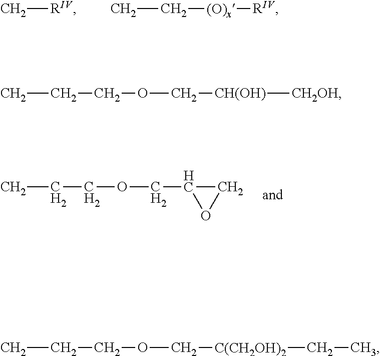
where
x′ is 0 or 1 and
R^{IV} is an optionally substituted, optionally halogen-substituted hydrocarbon moiety having 1 to 50 carbon atoms,
R₁ is R or R₃ or R₇,
2 is R or R₃ or R₇ or a heteroatom-substituted, functional, organic, saturated or unsaturated moiety,
R₃ is -Q-O—(CH₂—CH₂O—)ₓ—(CH₂—CH(R′)O—)_{y}—(SO)_{z}—R″ or
-Q-O—(CH₂—CH₂O—)ₓ—(CH₂—CH(R′)O—)_{y}—R″,
where
Q=divalent hydrocarbon moiety having 2 to 4 carbon atoms,
x=0 to 200,
y=0 to 200,
z=0 to 100,
R′ is an alkyl or aryl group which has 1 to 12 carbon atoms and is unsubstituted or optionally substituted with alkyl moieties, aryl moieties, haloalkyl moieties or haloaryl moieties, and
R″ is a hydrogen moiety or an alkyl group having 1 to 4 carbon atoms, a —C(O)—R′″ group where R′″=alkyl, a —CH₂—O—R′ group, an alkylaryl group, a —C(O)—OR′ group, or a —C(O)NH—R′ group,
SO is a styrene oxide moiety —CH(C₆H₅)—CH₂—O—,
R₇=branched polyether moiety or crosslinker moiety derived from diallyl compounds or converted diallyl compounds,
with the proviso that at least one moiety is an R₃ moiety and at least one R₃ moiety is a polyether moiety having a molecular weight of not less than 4500 g/mol, and R″ is ═H and n+n¹+m+m¹ is not less than 15.

6. The process according to claim 5, wherein R″ is hydrogen for all polyether moieties R₃ having a molecular weight not less than 4500 g/mol.

7. The process according to claim 5, wherein R″ is other than hydrogen for all polyether moieties R₃ having a molecular weight below 4500 g/mol.

8. The process according to claim 1, wherein said silicone-polyether copolymer is present in a composition containing nucleating agents, cell-refining additives, cell openers, crosslinkers, emulsifiers, flame retardants, antioxidants, antistats, biocides, colour pastes, solid fillers, amine catalysts, metal catalysts and buffer substances.

9. The process according to claim 8, wherein the composition further contains one or more solvents.

10. The process according to claim 1, wherein said reacting is performed in the presence of at least one of water, methylene chloride, pentane, alkanes, cyclopentane, halogenated alkanes, acetone or carbon dioxide.

11. A polyurethane foam obtainable by a process according to claim 1, said polyurethane foam having a density of below 24 kg/m³.

12. An article comprising a polyurethane foam according to claim 11.
